(19) United States
(12) Patent Application Publication
(10) Pub. No.: US 2004/0250951 A1
(43) Pub. Date: Dec. 16, 2004

(54) Roll identification label and method for making the same

(76) Inventor: Daniel Brian Noworatzky, Appleton, WI (US)

Correspondence Address: BIRCH STEWART KOLASCH & BIRCH, PO BOX 747, FALLS CHURCH, VA, 22040-0747, US

(21) Appl. No.: 10/458,642

(22) Filed: Jun. 11, 2003

(51) Int. Cl. B32B 31/00

(52) U.S. Cl. 156/277; 40/638

(57) ABSTRACT

An identification label for a roll of paper and a method of making the label. The back of the label has adhesive only in selected portions corresponding to the central roll of the paper. The label adheres to the end of the roll but not the paper wound thereon. The central area of the label is cut in a star pattern to form triangular sections which adhere to the inside surface of the core. A method is also provided for labeling a product rolled about a core by adhering such a label.

### BACKGROUND OF THE INVENTION

1. Field of the Invention

This invention relates generally to a label to identify a roll of paper or similar product and more particularly to a roll identification label having limited adhesion and a method for making the same.

2. Description of the Prior Art

During manufacture of paper or other similar sheet products, it is common to roll the completed product around a central core. In order to identify the material, to apply trademarks and other identifying indicia to the roll, a number of different techniques used. Due to the cylindrical shape of the wound product, it is common to apply these indicia to the flat end surface. This avoids the necessity to apply the indicia to a curved surface and prevents the possibility that it would be removed when part of the product is unwound. In addition, the indicia would still be visible if a protective wrap were added around the curved surface of the cylinder.

A number of different types of indicia have been attempted in the past. One simple technique is to apply the indicia by way of a rubber stamp, stencil or other similar tool in order to apply ink, paint or other material to this surface. While simple and inexpensive, this type of technique has disadvantages. First, such markings are permanent and if incorrectly applied, may be difficult or impossible to remove. Sometimes, it is difficult to make the indicia uniform from one side to the other. The stamp may wear unevenly or the person stamping may not hold the stamp perfectly parallel to the surface, causing one side to be darker than the other. If too much ink or paint is applied, it may smear. Another alternative is to use an ink jet apparatus in order to apply the ink in a sprayed ink pattern. However, again, the information is permanent and is difficult to remove. Furthermore, it is difficult to spray enough ink to make the indicia readable yet not penetrate into the sheets of paper.

Another manner of applying indicia is to use labels with adhesive. These labels are often square. However, such square labels may cause the sheet to break during unwinding because the adhesive may stick to the sheet and make it difficult to unwind and accordingly cause the sheet to tear. In addition, the square label can sometimes act as a blade and cut the sheet as it is unwinding past the label. In addition, no matter what the shape of the label, the adhesive can migrate onto the paper so that various layers will stick together causing the sheet to tear during unwinding. Some adhesives can also be chemically destructive to the paper. The label can also fall off during processing into the traveling material and damage the material. Since some customers do not use the full roll at one time, the label must be removed and replaced so that the adhesive must be reusable.

U.S. Pat. No. 5,622,591 shows a method for attaching an end disc to a roll of film. Radial cuts provide a plurality of tabs which can be folded into the central bore of the core of the film.

U.S. Pat. No. 2,019,952 shows a shuttle bobbin having end pieces with a star cut center section which is folded in to adhere to the inside surface of the core.

U.S. Pat. No. 3,500,364 shows a card label for an electronic disc where adhesive is applied to only part of the back of the card.

### SUMMARY OF THE INVENTION

Accordingly, the present invention provides a label for a roll of paper.

The present invention further provides an identification label for a roll of sheet product.

The present invention further provides a label for attachment to an end surface of a paper roll.

The present invention still further provides an identification label for a paper roll having adhesive only on part of the label.

The present invention also provides a permanent roll identification label which is attached only to the core of the roll.

The present invention still further provides an identification label having adhesive on part of the label and having a star cut center for attachment to the core of a roll.

The present invention also provides a method for making a label which adheres only to the core of a roll.

The present invention achieves this by providing a circular label onto which identification indicia is placed and having adhesive for attachment to a core of a roll with the adhesive being limited to the area of the core. The center of the label is star cut so that it may be pushed into the central opening of the core for attachment of the adhesive to the inside of the core.

These objects are also fulfilled by providing a label with a front and rear side where indicia is applied to the front side and adhesive is applied to a portion of the rear side and adhering to the core such that the label fails to be adhered to the product.

Further, these objects are fulfilled by a label with a front surface having indicia, a rear surface contactable with an inner surface of a core and means for adhering to label only to the core so that the label fails to be adhered to a product rolled about the core.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a perspective view of a roll of paper;

FIG. 2 is a perspective view of a roll of paper having an identification label in accordance with the present invention;

FIG. 3A shows a front view of an identification label according to the present invention; and

FIG. 3B shows a front view of a core of a roll and its relationship to the identification label of the present invention.

### DETAILED DESCRIPTION OF THE PREFERRED EMBODIMENTS

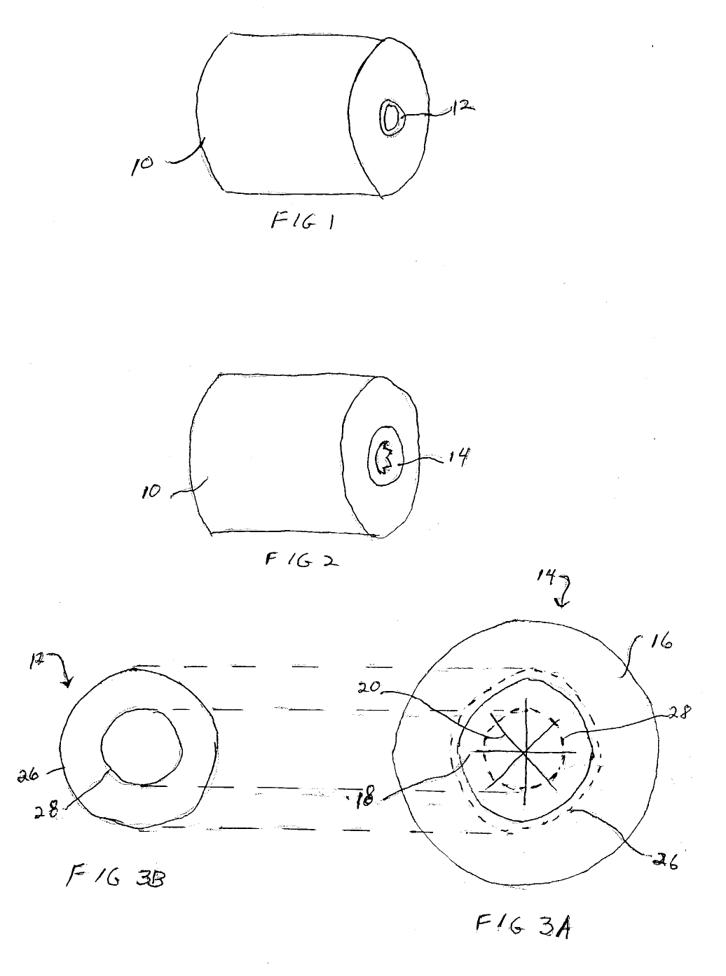

Referring now to the drawings wherein like reference numerals identify identical or corresponding parts throughout the several views and more particularly to FIG. 1, wherein a roll of paper 10 is shown in a cylindrical form. A central core 12 about which the paper is wound is shown as having an end visible on the end face of the roll. While the material is described as being paper, in fact any type of sheet material which is capable of being wound can be used with the present invention.

FIG. 2 shows the same roll of paper 10, but this time having a label 14 mounted on the end surface of the roll and more particularly on the end surface of the core.

FIGS. 3A and 3B show the label and the core, respectively and their respective sizes. Core 12, shown in FIG. 3B has an outer edge 26 and an inner edge 28. The core is hollow inside the inner edge, as is commonly known in the art.

The label 14, shown in FIG. 3A is made of paper or similar material in the form of the circle. The indicia are printed on the face of the circle using standard techniques. The back of the label receives adhesive on various parts thereof. In particular, the outer part 16 in the shape of a ring has no adhesive. The inner part 18 in the shape of a circle within the ring 16 does contain adhesive on the backside. The circle 18 is smaller than the outer edge of the core, so that the adhesive area is limited to the area of the core. This prevents any adhesive from getting on the paper. The relative positions of the edges of the core are seen in FIG. 3A by the two circles made of dotted lines. As is seen, the circle 18 fits within the outer dotted circle and the inner dotted circle falls within the adhesive circle 18.

A series of star cuts 20 are provided within the circle 18. While four such cuts are shown, any number may be provided. These cuts extend through the label. When the label is placed on the roll end, the adhesive in section 18 adheres to the roll end between edges 26 and 28. If the star cut is pushed in a direction perpendicular to the surface of the label, the cuts 20 will allow a series of triangular shaped pieces to be pushed inside the roll. When these pieces contact the inside wall of the roll, they adhere thereto so as to firmly attach the label to the inner wall of the core. Thus, the label will be adhered to the core both on the end surface and also to the inside wall, making it permanently affixed. Thus, this arrangement provides for adherence in two different planes making it less likely for the label to fall off.

At the same time, the adhesive is limited to the area within the outer edge of the core so that adhesive will not be against the edge of the paper. This prevents adhesive from causing the paper to stick together and causing tearing as it unrolls. Although this has been described as not applying adhesive to the outer area 16, it is also possible to apply adhesive to the complete rear surface of the label and then laminate outer part 18 with some material such as a release liner that prevents contact between the paper and the adhesive. It would also be possible to apply a chemical to “deaden” the adhesive, that is, to destroy its tacky properties.

By utilizing the patterned arrangement of adhesive, many of the disadvantages of using adhesive labels are removed since the adhesive does not come into contact with the paper. Further, by using the star cut center, the adhesive is firmly attached and not easily knocked off. When using a label rather than a stamp or stencil, the quality of the printing may be maintained in an easier fashion.

The use of this label then provides a method for labeling a product rolled about the core by applying indicia to the front side of the label and applying adhesive to the rear side of the label and then adhering the label to the core so that the adhesive pattern is contained within an inner surface of the core so that the label fails to be adhered to the product.

Although the label has been described in terms of an adhesive being applied to the rear of the label, any means for adhering the label to the core which allows it to be attached without being adhered to the product can be used. Thus, this means maybe any sticky substance including glue, paste, tars or other sticky materials, or may be other means such as hook and eye fasteners, staples or other physical fasteners.

Numerous additional modifications and variations of the present invention are possible in light of the above teachings. It is therefore to be understood that within the scope of the appended claims, the invention may be practices otherwise than as specifically described herein.

We claim:

1. A label for a product rolled about a core, said label comprising:
a front surface having indicia;
a rear surface contactable with an end surface of said core;
said rear surface having adhesive thereon in a pattern contained within said end surface of said core, said pattern of adhesive failing to cover said rear surface of said label which extends beyond said core when said label is applied to said core.

2. The label according to claim 1, wherein said label is circular.

3. The label according to claim 1, further comprising a plurality of cuts in an area corresponding to a center of the core so as to form triangular segments which are bendable and adherable to an inner surface of said core.

4. The label according to claim 1, wherein the indicia is identification indicia indicating the source of origin of the product.

5. The label according to claim 1, wherein the indicia indicates various qualities about the product.

6. The label according to claim 1, wherein the label overlays said product and said rear surface fails to adhere to said product.

7. The label according to claim 6, wherein said end surface and said label are circular.

8. The label according to claim 7, further comprising a plurality of cuts in an area corresponding to a center of the core so as to form triangular segments which are bendable and adherable to an inner surface of said core.

9. The label according to claim 8, wherein the indicia is identification indicia indicating the source of origin of the product.

10. A method for labeling a product rolled about a core, comprising:
providing a label having a front side and a rear side;
applying indicia to said front side;
applying adhesive to a portion of said rear side;
adhering said label to said core such that said label fails to be adhered to said product.

11. The method according to claim 10, wherein said adhesive is applied in a pattern to be contained within an end surface of said core.

12. The method according to claim 10, wherein said adhesive is applied to the entire rear surface and part of said adhesive is prevented from adhering.

13. The method according to claim 12, wherein said adhesive is prevented from adhering by a release liner.

14. The method according to claim 12, wherein said adhesive is prevented from adhering by chemical deadening.

15. A label for a product rolled about a core, said label comprising:
a front surface having indicia;
a rear surface contactable with an end surface of said core; and
means for adhering said label only to said core so that said label fails to be adhered to said product.

16. The label according to claim 15, wherein said label is circular.

17. The label according to claim 15, wherein said means for adhering includes adhesive placed in a pattern contained within said end surface.

18. The label according to claim 15, wherein said means for adhering includes adhesive applied to the entire rear surface and covering part of said rear surface with a release liner.

19. The label according to claim 15, wherein said means for adhering includes adhesive applied to the entire rear surface with part of said surface being chemically deadened.

20. The label according to claim 15, said label further comprising a plurality of cuts in an area corresponding to a center of said core so as to form triangular segments which are bendable and adherable to an inner surface of said core.
